(19) United States
(12) Patent Application Publication
(10) Pub. No.: US 2026/0035560 A1
(43) Pub. Date: Feb. 5, 2026

(54) RESIN COMPOSITION AND ARTICLE MADE THEREFROM

(71) Applicant: Elite Material Co., Ltd., Taoyuan City (TW)

(72) Inventor: Chen-Yu HSIEH, Taoyuan City (TW)

(21) Appl. No.: 18/817,579

(22) Filed: Aug. 28, 2024

(30) Foreign Application Priority Data
Aug. 1, 2024 (TW) 113128724

(51) Int. Cl. C08L 71/12; C08J 5/24; C08K 3/26; C08K 3/28; C08K 3/36; C08K 5/01; C08K 5/14; C08L 9/06; C08L 35/06; C08L 79/08

(52) U.S. Cl. CPC C08L 71/126; C08J 5/244; C08K 3/28; C08K 3/36; C08K 5/01; C08K 5/14; C08L 9/06; C08L 35/06; C08L 79/085; C08J 2335/06; C08J 2371/12; C08J 2379/08; C08J 2409/06; C08K 2003/267; C08K 2003/282; C08L 2203/16; C08L 2203/20

(57) ABSTRACT

A resin composition includes 100 parts by weight of a thermosetting resin, 10 parts by weight to 40 parts by weight of a fluorene-containing compound and 210 parts by weight to 400 parts by weight of silica. The resin composition may be used to make various articles, including a resin film, a prepreg, a laminate or a printed circuit board, and at least one or more of the following properties can be improved, including PCT water absorption ratio, dielectric constant, dissipation factor, copper foil peeling strength, thermal conductivity and glass transition temperature.

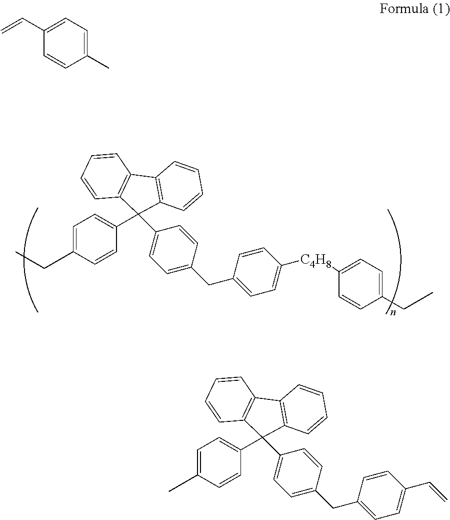

### CROSS-REFERENCE TO RELATED APPLICATION

This application claims the priority benefits of Taiwan Patent Application No. 113128724, filed on Aug. 1, 2024. The entirety of the above-mentioned patent application is hereby incorporated by reference herein and made a part of this specification.

### BACKGROUND

### 1. Field of the Disclosure

The present disclosure relates to a resin composition and more particularly to a resin composition useful for preparing a prepreg, a resin film, a laminate or a printed circuit board.

### 2. Description of Related Art

In recent years, due to the development of electronic signal transmission toward 5G and the trend of miniaturization and high performance of electronic equipment, communication devices and personal computers, circuit boards for these applications were also developed toward multi-layer configuration, high density trace interconnection, and high speed signal transmission, thereby presenting higher challenges to the overall performance of circuit laminates such as copper-clad laminates.

Accordingly, there is a need to provide a novel material meeting the property requirements of circuit boards used nowadays.

### SUMMARY

To overcome the problems of prior arts, particularly one or more property demands facing conventional materials, it is a primary object of the present disclosure to provide a resin composition and an article made from the resin composition, which may achieve at least one or more desirable property improvements including PCT water absorption ratio, dielectric constant, dissipation factor, copper foil peeling strength, thermal conductivity and glass transition temperature.

To achieve the above-mentioned objects, the present disclosure provides a resin composition, comprising:
100 parts by weight of a thermosetting resin;
10 parts by weight to 40 parts by weight of a fluorene-containing compound; and
210 parts by weight to 400 parts by weight of silica;
   wherein the fluorene-containing compound has a structure of Formula (1), and
   n is between 0 and 2:

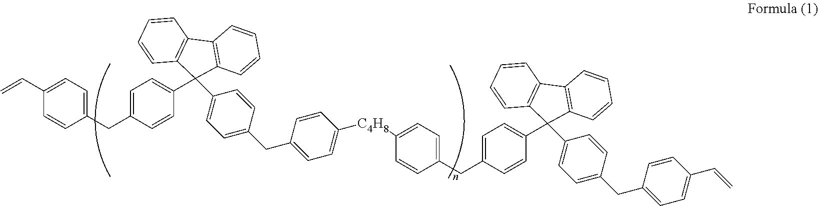

the thermosetting resin comprises a vinyl group-containing polyphenylene ether resin, a maleimide resin, a styrene-based compound or a combination thereof, wherein the styrene-based compound has a structure of Formula (2), and w is between 1 and 20:

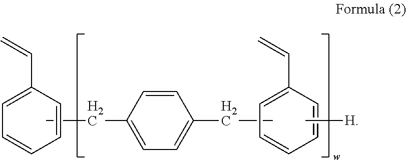

For example, in one embodiment, the vinyl group-containing polyphenylene ether resin comprises a vinylbenzyl group-containing biphenyl polyphenylene ether resin, a methacrylate group-containing polyphenylene ether resin or a combination thereof.

For example, in one embodiment, the maleimide resin comprises 4,4′-diphenylmethane bismaleimide, polyphenylmethane maleimide, bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-dimethylphenyl maleimide, N-2,6-dimethylphenyl maleimide, N-phenylmaleimide, vinyl benzyl maleimide, maleimide containing biphenyl structure, maleimide containing indane structure, maleimide resin containing C₁₀ to C₅₀ aliphatic long chain structure or a combination thereof.

For example, in one embodiment, the resin composition of the present disclosure further comprises an additive. For example, in one embodiment, the additive includes polyolefin, vinylbenzocyclobutene, vinylnorbornene or a combination thereof.

For example, in one embodiment, the resin composition of the present disclosure further comprises inorganic filler different from silica, flame retardant, curing accelerator, polymerization inhibitor, solvent, silane coupling agent, coloring agent, toughening agent, or a combination thereof.

In another aspect, the present disclosure also provides an article made from the resin composition described above, which comprises a prepreg, a resin film, a laminate or a printed circuit board.

For example, in one embodiment, the article described above has at least one, more or all of the following properties:
a water absorption ratio in a pressure cooking test (PCT water absorption ratio) as measured by reference to IPC-TM-650 2.6.16.1 of less than or equal to 0.33%;
a dielectric constant as measured by reference to JIS C2565 at 10 GHz of less than or equal to 3.12;
a dissipation factor as measured by reference to JIS C2565 at 10 GHz of less than or equal to 0.0029;
a copper foil peeling strength as measured by reference to IPC-TM-650 2.4.8 of greater than or equal to 3.13 lb/in;
a thermal conductivity as measured by reference to ASTM-D5470 of greater than or equal to 0.21 W/(m·K); and
a glass transition temperature as measured by reference to IPC-TM-650 2.4.24.5 of greater than or equal to 202° C.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, the term “comprises,” “comprising,” “includes,” “including,” “has,” “having” or any other variant thereof is construed as an open-ended transitional phrase intended to cover a non-exclusive inclusion. For example, a composition comprising a list of elements or an article made therefrom encompasses any one or any type of the listed elements and is not necessarily limited to only those elements listed herein, but may also include other elements not expressly listed or inherent to such composition or article. Further, unless expressly stated to the contrary, the term “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). In addition, whenever open-ended transitional phrases are used, such as “encompasses,” “encompassing,” “comprises,” “comprising,” “includes,” “including,” “has,” “having” or any other variant thereof, it is understood that close-ended transitional phrases such as “consisting of,” “composed by” and “remainder being” and partially open-ended transitional phrases such as “consisting essentially of,” “primarily consisting of,” “mainly consisting of,” “primarily containing,” “composed essentially of,” “essentially having,” etc. are also disclosed and included.

As used herein, “or a combination thereof” means “or any combination thereof”, which encompasses any combination of two or more of the listed elements, and “any” means “any one”, vice versa. For example, “a composition or an article made therefrom includes A, B, C or a combination thereof” is construed to encompass the following situations: A is true (or present), and B and C are false (or not present); B is true (or present), and A and C are false (or not present); C is true (or present), and A and B are false (or not present); A and B are true (or present), and C is false (or not present); A and C are true (or present), and B is false (or not present); B and C are true (or present), and A is false (or not present); and A and B and C are all true (or present), and it is also contemplated that the composition or an article thereof contains or does not contain elements other than A, B and C not expressly listed but inherent to such composition or article.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features and conditions such as values, numbers, contents, amounts or concentrations are presented as a numerical range or a percentage range merely for convenience and brevity. Therefore, a numerical range or a percentage range should be interpreted as encompassing and specifically disclosing all possible subranges and individual numerals or values therein, including integers and fractions, particularly all integers therein. For example, a range of “1.0 to 8.0” or “between 1.0 and 8.0” should be understood as explicitly disclosing all subranges such as 1.0 to 8.0, 1.0 to 7.0, 2.0 to 8.0, 2.0 to 6.0, 3.0 to 6.0, 4.0 to 8.0, 3.0 to 8.0 and so on and encompassing the endpoint values, particularly subranges defined by integers, as well as disclosing all individual values in the range such as 1.0, 2.0, 3.0, 4.0, 5.0, 6.0, 7.0 and 8.0. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X₁, X₂ and X₃,” it is intended to disclose the situations of X is X₁ and X is X₁ and/or X₂ and/or X₃. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X₁, X₂ and X₃” and Y is described as being “selected from a group consisting of Y₁, Y₂ and Y₃,” the disclosure encompasses any combination of X is X₁ and/or X₂ and/or X₃ and Y is Y₁ and/or Y₂ and/or Y₃.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto. A homopolymer refers to the polymer formed by the polymerization of one monomer. A copolymer refers to the polymer formed by the polymerization of two or more types of monomers. Copolymers comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. For example, in the present disclosure, a butadiene-styrene copolymer is interpreted as comprising a butadiene-styrene random copolymer, a butadiene-styrene alternating copolymer, a butadiene-styrene graft copolymer or a butadiene-styrene block copolymer. A prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured. The term “polymer” includes but is not limited to an oligomer. An oligomer refers to a polymer with 2 to 20, typically 2 to 5, repeating units.

Unless otherwise specified, the term “resin” of the present disclosure is a widely used common name of a synthetic polymer and is construed as comprising monomer and its combination, polymer and its combination or a combination of monomer and its polymer, but not limited thereto.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from copolymerizing a resin and other resins, etc.

The unsaturated bond described herein, unless otherwise specified, refers to a reactive unsaturated bond, such as but not limited to an unsaturated double bond with the potential of being crosslinked with other functional groups, such as an unsaturated C═C double bond with the potential of being crosslinked with other functional groups, but not limited thereto. The unsaturated C═C double bond as used herein preferably comprises, but not limited to, a vinyl group, a styryl group, a vinylbenzyl group, a (meth)acryloyl group, an allyl group or a combination thereof. The term “vinyl group” is construed as comprising a vinyl group and a vinylene group, and the term “(meth)acryloyl group” is construed as comprising an acryloyl group and a methacryloyl group.

Unless otherwise specified, the alkyl group, the alkenyl group and the monomer described herein are construed to encompass various isomers thereof. For example, a propyl group is construed to encompass n-propyl and iso-propyl.

Unless otherwise specified, as used herein, part(s) by weight represents weight part(s) in any weight unit in the resin composition, such as but not limited to kilogram, gram, pound and so on. For example, 100 parts by weight of the thermosetting resin may represent 100 kilograms of the thermosetting resin or 100 pounds of the thermosetting resin. Unless otherwise specified, in the present disclosure, wt % represents weight (or mass) percentage.

It should be understood that all features disclosed herein may be combined in any way to constitute the technical solution of the present disclosure, as long as there is no conflict present in the combination of these features.

Examples and embodiments are described in detail below. It will be understood that these examples and embodiments are exemplary only and are not intended to limit the scope and use of the present disclosure. Unless otherwise specified, processes, reagents and conditions described in the examples are those known in the art.

As described above, the present disclosure provides a resin composition, comprising the following components:
100 parts by weight of a thermosetting resin;
10 parts by weight to 40 parts by weight of a fluorene-containing compound; and
210 parts by weight to 400 parts by weight of silica;
   wherein the fluorene-containing compound has a structure of Formula (1), and n is between 0 and 2 (for example, n is 0, 1 or 2):

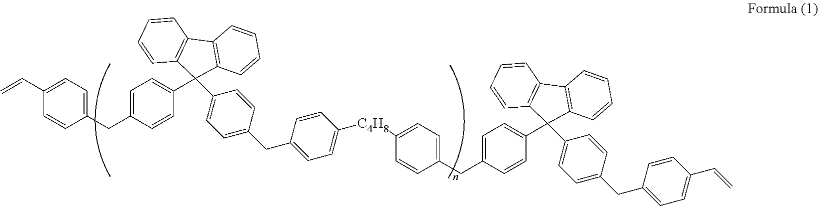

the thermosetting resin comprises a vinyl group-containing polyphenylene ether resin, a maleimide resin, a styrene-based compound or a combination thereof, wherein the styrene-based compound has a structure of Formula (2), and w is between 1 and 20:

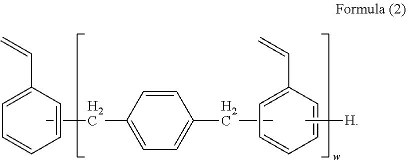

For example, in the present disclosure, if n is 0 in the structure of Formula (1), the fluorene-containing compound can be regarded as having a monomer structure. On the other hand, if n is 1 or 2 in the structure of Formula (1), the fluorene-containing compound can be regarded as having an oligomer structure. Relative to 100 parts by weight of the thermosetting resin, the amount of the fluorene-containing compound is 10 parts by weight to 40 parts by weight, such as but not limited to 10 parts by weight, 15 parts by weight, 20 parts by weight, 25 parts by weight, 30 parts by weight, 35 parts by weight or 40 parts by weight.

For example, in the present disclosure, examples of the silica include but are not limited to fused, non-fused, spherical, porous or hollow type silica; in addition, the silica may be optionally pretreated by a surface treating agent. For example, the surface treating agent may comprise silane coupling agent, organosilicon oligomer, titanate coupling agent or a combination thereof. The addition of the surface treating agent may promote the dispersivity of the inorganic filler and the compatibility with resin components.

Unless otherwise specified, the silica used herein may comprise any one or more commercially available products, products prepared by the Applicant (i.e., self-prepared products) or a combination thereof. For example, the silica used herein may be obtained by a chemical synthesis process in which the synthesis conditions are controlled to obtain the silica described herein. In addition, unless otherwise specified, the silica described herein may have any particle size, such as a particle size distribution of 0.01 μm to 15 μm, such as a particle size distribution of 0.1 μm to 10 μm.

The silica used herein may be spherical, fibrous, plate-like, particulate, flake-like, whisker-like or a combination thereof, preferably spherical in shape, including solid spheres and hollow spheres.

In addition, the silica described herein may be optionally pretreated by a silane coupling agent. Silane coupling agent suitable for the present disclosure may comprise silane (such as but not limited to siloxane), which may be further categorized according to the functional groups into amino silane, epoxide silane, vinyl silane, acrylate silane, methacrylate silane, hydroxyl silane, isocyanate silane, methacryloxy silane and acryloxy silane. For example, the silica is surface-pretreated by vinyl silane, methacryloxy silane and acryloxy silane.

For example, the silica described herein may be optionally modified by a molybdenum compound. For example, the molybdenum compound suitable for the present disclosure comprises, but not limited to, zinc molybdate, calcium molybdate, magnesium molybdate or a combination thereof.

Relative to 100 parts by weight of the thermosetting resin, the amount of silica is 210 parts by weight to 400 parts by weight, such as but not limited to 210 parts by weight, 230 parts by weight, 250 parts by weight, 265 parts by weight, 300 parts by weight, 350 parts by weight or 400 parts by weight.

According to the present disclosure, the thermosetting resin comprises a vinyl group-containing polyphenylene ether resin, a maleimide resin, a styrene-based compound of Formula (2) or a combination thereof.

For example, the vinyl group-containing polyphenylene ether resin may include but is not limited to a polyphenylene ether resin containing a vinyl group, an allyl group, a vinylbenzyl group or a methacrylate group. For example, in one embodiment, the vinyl group-containing polyphenylene ether resin comprises a vinylbenzyl group-containing biphenyl polyphenylene ether resin, a methacrylate group-containing polyphenylene ether resin (i.e., methacryloyl group-containing polyphenylene ether resin), an allyl group-containing polyphenylene ether resin, a vinylbenzyl group-modified bisphenol A polyphenylene ether resin, a chain-extended vinyl group-containing polyphenylene ether resin or a combination thereof. For example, the vinyl group-containing polyphenylene ether resin may be a vinylbenzyl group-terminated polyphenylene ether resin with a number average molecular weight of about 1200 (such as OPE-2st 1200, available from Mitsubishi Gas Chemical Co., Inc.), a vinylbenzyl group-terminated polyphenylene ether resin with a number average molecular weight of about 2200 (such as OPE-2st 2200, available from Mitsubishi Gas Chemical Co., Inc.), a methacrylate group-containing polyphenylene ether resin with a number average molecular weight of about 1900 to 2300 (such as SA9000, available from Sabic), a vinylbenzyl group-modified bisphenol A polyphenylene ether resin with a number average molecular weight of about 2400 to 2800, a chain-extended vinyl group-containing polyphenylene ether resin with a number average molecular weight of about 2200 to 3000, or a combination thereof. The chain-extended vinyl group-containing polyphenylene ether resin may include various polyphenylene ether resins disclosed in the US Patent Application Publication No. 2016/0185904 A1, all of which are incorporated herein by reference in their entirety.

For example, the maleimide resin may comprise 4,4′-diphenylmethane bismaleimide, polyphenylmethane maleimide (a.k.a. oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenyl methane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylyl maleimide, N-phenylmaleimide, vinyl benzyl maleimide (VBM), maleimide containing biphenyl structure, maleimide containing indane structure, maleimide resin containing C₁₀ to C₅₀ aliphatic long chain structure, prepolymer of diallyl compound and maleimide resin, prepolymer of multi-functional amine (i.e., an amine including two or more amino groups) and maleimide resin, prepolymer of acid phenol compound and maleimide resin, or a combination thereof. These components should be construed as including their modifications.

For example, examples of the maleimide resin include but are not limited to products such as BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000, and BMI-7000H available from Daiwakasei Industry, products such as BMI-70 and BMI-80 available from K.I Chemical Industry Co., Ltd., or products such as MIR-3000 and MIR-5000 available from Nippon Kayaku. For example, examples of the maleimide resin containing aliphatic long chain structure (such as containing C₁₀ to C₅₀ aliphatic long chain structure) include, but are not limited to, products such as BMI-689, BMI-1400, BMI-1500, BMI-1700, BMI-2500, BMI-3000, BMI-5000 and BMI-6000 available from Designer Molecules Inc.

In addition to the aforesaid thermosetting resin, fluorene-containing compound and silica, the resin composition of the present disclosure may further comprise an additive. The additive suitable for the present disclosure is not particularly limited and may include any one or more additives useful for making a prepreg, a resin film, a laminate, or a printed circuit board, such as any one or more commercial products, products prepared by the Applicant or a combination thereof. For example, in one embodiment, the additive includes polyolefin, vinylbenzocyclobutene, vinylnorbornene or a combination thereof.

The polyolefin suitable for the present disclosure is not particularly limited and may include any one or more olefin polymers useful for making a prepreg, a resin film, a laminate, or a printed circuit board, such as any one or more commercial products, products prepared by the Applicant or a combination thereof.

For example, the polyolefin described herein includes but is not limited to a diene polymer, a monoene polymer, a hydrogenated diene polymer or a combination thereof, generally having a number average molecular weight of between 1,000 to 150,000.

In some embodiments, examples of the polyolefin include but are not limited to: polybutadiene, polyisoprene, butadiene-styrene copolymer, polydicyclopentadiene, styrene-isoprene copolymer, styrene-butadiene-divinylbenzene terpolymer, styrene-butadiene-maleic anhydride terpolymer, vinyl-polybutadiene-urethane oligomer, maleic anhydride-butadiene copolymer, polymethylstyrene, styrene-maleic anhydride copolymer, hydrogenated styrene-butadiene-divinylbenzene terpolymer, hydrogenated styrene-butadiene-maleic anhydride terpolymer, hydrogenated styrene-butadiene copolymer, hydrogenated styrene-isoprene copolymer, maleic anhydride-modified polybutadiene-styrene copolymer or a combination thereof. These components should be construed as including their modifications. According to the present disclosure, the polyolefin is interpreted as comprising a random copolymer, an alternating copolymer, a graft copolymer, a block copolymer or a combination thereof.

In one embodiment, for example, the resin composition of the present disclosure may further optionally comprise inorganic filler different from silica, flame retardant, curing accelerator, polymerization inhibitor, solvent, silane coupling agent, coloring agent, toughening agent or a combination thereof. Unless otherwise specified, relative to 100 parts by weight of the thermosetting resin, the content of any aforesaid component may be 0.001 to 400 parts by weight, such as 0.001, 0.01, 0.1, 1, 5, 10, 20, 30, 40, 50, 60, 70, 80, 90, 100, 150, 200, 250, 300, 350, 370 or 400 parts by weight, such as 30 to 150 parts by weight or 160 to 370 parts by weight.

In one embodiment, for example, the inorganic filler different from silica may be any one or more inorganic fillers used for preparing a resin film, a prepreg, a laminate or a printed circuit board, examples including but not limited to aluminum oxide, aluminum hydroxide, magnesium oxide, magnesium hydroxide, magnesium carbonate, calcium carbonate, aluminum nitride, boron nitride, aluminum silicon carbide, silicon carbide, titanium dioxide, zinc oxide, zirconium oxide, mica, boehmite (AlOOH), calcined talc, talc, silicon nitride, calcined kaolin, hollow porous particle or a combination thereof. Moreover, the inorganic filler different from silica can be spherical, fibrous, plate-like, particulate, flake-like, whisker-like or a combination thereof in shape and can be optionally pretreated by a silane coupling agent. For example, relative to 100 parts by weight of the thermosetting resin, the amount of inorganic filler different from silica used in the present disclosure may range from 1 part by weight to 300 parts by weight or 60 parts by weight to 120 parts by weight. In another embodiment, the resin composition may include no inorganic filler different from silica. In this case, the amount of inorganic filler different from silica is 0 part by weight, which means that the resin composition is not intentionally added with inorganic filler different from silica.

For example, the flame retardant used herein may be any one or more flame retardants useful for preparing a prepreg, a resin film, a laminate or a printed circuit board, examples including but not limited to a phosphorus-containing flame retardant, preferably comprising ammonium polyphosphate, hydroquinone bis-(diphenyl phosphate), bisphenol A bis-(diphenylphosphate), tri(2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), phosphazene (such as commercially available SPB-100, SPH-100, and SPV-100), melamine polyphosphate, DOPO (9,10-dihydro-9-oxa-10-phosphaphenanthrene-10-oxide) and its derivatives or resins, DPPO (diphenylphosphine oxide) and its derivatives or resins, melamine cyanurate, tri-hydroxy ethyl isocyanurate, aluminium phosphinate (e.g., commercially available OP-930 and OP-935), and a combination thereof.

For example, the flame retardant may be a DPPO compound (e.g., di-DPPO compound, such as commercially available PQ-60), a DOPO compound (e.g., di-DOPO compound), a DOPO resin (e.g., DOPO-HQ, DOPO-NQ, DOPO-PN, and DOPO-BPN) and a DOPO-containing epoxy resin, wherein DOPO-PN is a DOPO phenol novolac compound, and DOPO-BPN may be a DOPO-containing bisphenol novolac compound, such as DOPO-BPAN (DOPO-bisphenol A novolac), DOPO-BPFN (DOPO-bisphenol F novolac) or DOPO-BPSN (DOPO-bisphenol S novolac).

The curing accelerator (including curing initiator) may comprise a catalyst, such as a Lewis base or a Lewis acid. The Lewis base may comprise any one or more of imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate.

The curing accelerator may also encompass curing initiator such as a peroxide capable of producing free radicals, and examples of the curing initiator may comprise but not limited to: benzoyl peroxide, dicumyl peroxide, 2,5-dimethyl-2,5-di(t-butylperoxy)hexane, 2,5-dimethyl-2,5-di(t-butylperoxy)-3-hexyne, di-t-butyl peroxide, di(t-butylperoxyisopropyl)benzene, di(t-butylperoxy)phthalate, di(t-butylperoxy)isophthalate, t-butyl peroxybenzoate, 2,2-di(t-butylperoxy)butane, 2,2-di(t-butylperoxy)octane, 2,5-dimethyl-2,5-di(benzoyl peroxy)hexane, lauroyl peroxide, t-hexyl peroxypivalate, dibutylperoxyisopropylbenzene, bis(4-t-butylcyclohexyl) peroxydicarbonate or a combination thereof. For example, relative to 100 parts by weight of the thermosetting resin, the amount of curing accelerator used in the present disclosure may range from 0.01 to 5 parts by weight, preferably 0.5 to 2 parts by weight.

In one embodiment, for example, the polymerization inhibitor used herein is not particularly limited and may be any polymerization inhibitor known in the field to which this disclosure pertains, including but not limited to various commercially available polymerization inhibitor products. For example, the polymerization inhibitor may comprise, but not limited to, 1,1-diphenyl-2-picrylhydrazyl radical, methyl acrylonitrile, dithioester, nitroxide-mediated radical, triphenylmethyl radical, metal ion radical, sulfur radical, hydroquinone, 4-methoxyphenol, p-benzoquinone, phenothiazine, β-phenylnaphthylamine, 4-t-butylcatechol, methylene blue, 4,4′-butylidenebis(6-t-butyl-3-methylphenol), 2,2′-methylenebis(4-ethyl-6-t-butyl phenol) or a combination thereof. For example, the nitroxide-mediated radical may comprise, but not limited to, nitroxide radicals derived from cyclic hydroxylamines, such as 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include such as 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1, 1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like. For example, in one embodiment, relative to 100 parts by weight of the thermosetting resin, the resin composition of the present disclosure may comprise 0.001 part by weight to 2 parts by weight of polymerization inhibitor.

The purpose of adding solvent is to change the solid content of the resin composition and to adjust the viscosity of the resin composition. For example, the solvent may comprise, but not limited to, methanol, ethanol, ethylene glycol monomethyl ether, acetone, butanone (methyl ethyl ketone), methyl isobutyl ketone, cyclohexanone, toluene, xylene, methoxyethyl acetate, ethoxyethyl acetate, propoxyethyl acetate, ethyl acetate, dimethylformamide, dimethylacetamide, propylene glycol methyl ether, or a mixture thereof. For example, relative to 100 parts by weight of the thermosetting resin, the amount of solvent used herein may be 100 parts by weight to 400 parts by weight, such as 150 parts by weight, 200 parts by weight, 250 parts by weight, 300 parts by weight or 350 parts by weight, but not limited thereto.

The silane coupling agent may include various silanes (such as but not limited to siloxane) or a combination thereof and may be further categorized according to the functional groups into amino silane, epoxide silane, vinyl silane, acrylate silane, methacrylate silane, hydroxyl silane, isocyanate silane, methacryloxy silane and acryloxy silane.

The coloring agent suitable for the present disclosure may comprise, but not limited to, dye or pigment.

The purpose of adding toughening agent is to improve the toughness of the resin composition. The toughening agent may comprise, but not limited to, rubber resin, carboxyl-terminated butadiene acrylonitrile rubber (CTBN rubber), core-shell rubber, or a combination thereof.

In addition to the aforesaid resin composition, the present disclosure also provides an article made from the resin composition, such as those suitable for use as components in various electronic products, including but not limited to a prepreg, a resin film, a laminate or a printed circuit board.

For example, the resin composition of the present disclosure can be used to make a prepreg, which comprises a reinforcement material and a layered structure disposed thereon. The layered structure is formed by heating the resin composition at a high temperature to the B-stage. Suitable baking temperature for making a prepreg may be for example 80° C. to 160° C., preferably 100° C. to 140° C. For example, the reinforcement material may be any one of a fiber material, woven fabric, and non-woven fabric, and the woven fabric preferably comprises fiberglass fabrics. The type of the fiberglass fabric is not particularly limited and may be any fiberglass fabrics used for a printed circuit board, such as E-glass fabric, D-glass fabric, S-glass fabric, T-glass fabric, L-glass fabric, Q-glass fabric or QL-glass fabric (glass fabric with hybrid structure made of Q-glass and L-glass). The fiber may comprise yarns and rovings, in spread form or standard form, and the shape of terminal face may be round or flat. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can also be optionally pre-treated by a silane coupling agent. The prepreg may be further heated and cured to the cured state (C-stage) to form an insulation layer.

For example, the resin composition of the disclosure can be used to make a resin film, which is prepared by heating and baking to semi-cure the resin composition. The resin composition may be selectively coated on a supporting material, which includes but is not limited to a liquid crystal polymer film, a polytetrafluoroethylene film, a polyethylene terephthalate film (PET film), a polyimide film (PI film), a metal foil or a resin-coated copper (RCC), followed by heating and baking to semi-cure the resin composition to form the resin film.

For example, the resin composition of the present disclosure may be made into a laminate, which comprises at least two metal foils and at least one insulation layer disposed between the metal foils, wherein the insulation layer is made by curing the resin composition at high temperature and high pressure to the C-stage, a suitable curing temperature being for example between 180° C. and 220° C. and preferably between 200° C. and 220° C. and a suitable curing time being 90 to 150 minutes and preferably 90 to 120 minutes, a suitable lamination pressure being for example between 200 psi and 500 psi and preferably between 250 psi and 500 psi. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

In one embodiment, the laminate may be further processed by trace formation processes to obtain a circuit board, such as a printed circuit board.

For example, in one embodiment, an article made from the resin composition from each embodiment contains a reinforcement material or a supporting material and a semi-cured or cured product obtained by heating and chemically crosslinking the resin composition.

In one or more embodiments, the articles made from the resin composition disclosed herein may have at least one, preferably at least two, more or all, of the following properties:
a water absorption ratio in a pressure cooking test (PCT water absorption ratio) as measured by reference to IPC-TM-650 2.6.16.1 of less than or equal to 0.33%, such as between 0.19% and 0.33%;
a dielectric constant as measured by reference to JIS C2565 at 10 GHz of less than or equal to 3.12, such as between 2.77 and 3.12;
a dissipation factor as measured by reference to JIS C2565 at 10 GHz of less than or equal to 0.0029, such as between 0.0016 and 0.0029;
a copper foil peeling strength as measured by reference to IPC-TM-650 2.4.8 of greater than or equal to 3.13 lb/in, such as between 3.13 lb/in and 3.35 lb/in;
a thermal conductivity as measured by reference to ASTM-D5470 of greater than or equal to 0.21 W/(m·K), such as between 0.21 W/(m·K) and 0.51 W/(m·K); and
a glass transition temperature as measured by reference to IPC-TM-650 2.4.24.5 of greater than or equal to 202° C., such as between 202° C. and 245° C.

Methods for measuring the aforesaid properties will be elaborated in detail below.

Raw materials below were used to prepare the resin compositions of various Examples and Comparative Examples of the present disclosure according to the amount listed in Table 1 to Table 4 and further fabricated to prepare test samples.

Materials and reagents used in Synthesis Examples, Examples and Comparative Examples disclosed herein are listed below:
SA9000: methacrylate group-containing polyphenylene ether resin, available from Sabic.
OPE-2St 2200: vinylbenzyl group-containing biphenyl polyphenylene ether resin, available from Mitsubishi Gas Chemical Co., Inc.
Compound of Formula (2): styrene-based compound, w=1 to 20, as described in Synthesis Example 1.

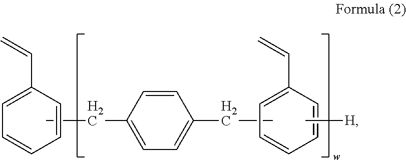

BMI-3000: maleimide resin containing aliphatic long-chain structure, available from Designer Molecules Inc.
MIR-5000: maleimide resin of Formula (3), 1≤m≤5, available from Nippon Kayaku.

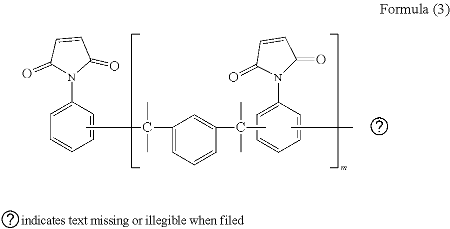

Fluorene-containing compound: having a structure of Formula (1), wherein n=0, available from Kingyorker Enterprise Co., Ltd.

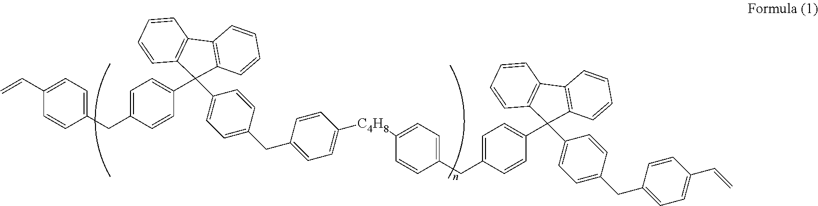

Fluorene-containing compound: having the structure of Formula (1), wherein n=1 to 2, available from Kingyorker Enterprise Co., Ltd.
Compound of Formula (4): prepared according to Example 1 (Compound 1, 9,9-bis(vinylbenzyl)fluorene) in Patent Application Publication WO2002/083610 A1, wherein n is 0, and R² is a hydrogen atom.

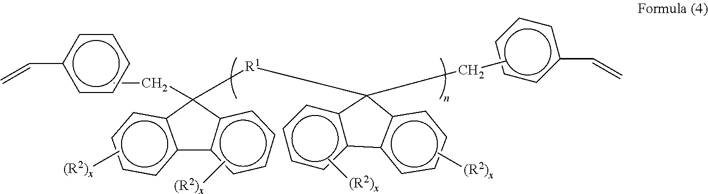

Compound of Formula (4): prepared according to Example 2 (Compound 2) in Patent Application Publication WO2002/083610 A1, wherein n is 10, R¹ is a xylylenyl group, and R² is a hydrogen atom.
Compound of Formula (5): 9,9-bis(4-(2-acryloyloxyethoxy)phenyl)fluorene, as shown below, commercially available.

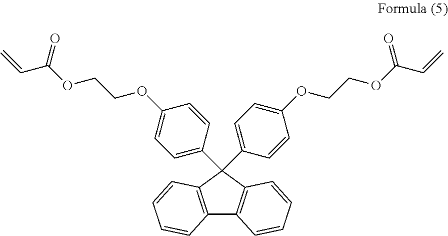 [SMILES: C=CC(=O)OCCOc1ccc(C2(c3ccc(OCCOC(=O)C=C)cc3)c3ccccc3-c3ccccc32)cc1]

Ricon 100: butadiene-styrene copolymer, available from Cray Valley.
PCX02: polydicyclopentadiene, available from Kingyorker Enterprise Co., Ltd.
H1052: hydrogenated styrene-butadiene copolymer, available from Asahi-Kasei.
B-1000: polybutadiene, available from Nippon Soda Co., Ltd.
Ricon 184MA6: maleic anhydride-modified polybutadiene-styrene copolymer, available from Cray Valley.
V-BCB: vinylbenzocyclobutene, available from Chemtarget Technologies Co., Ltd.
V-NB: vinylnorbornene, available from Tokyo Chemical Industry (TCI).
25B: 2,5-dimethyl-2,5-di(t-butylperoxy)-3-hexyne, available from NOF Corporation.
MEK: methyl ethyl ketone, commercially available. In the Tables, the amount symbol “R” of solvent represents the amount of solvent is a multiple of the total amount of all other components excluding inorganic filler, curing accelerator and solvent in the resin composition of each Example or each Comparative Example. In the Tables, “R*150%” represents the amount of solvent is 1.5 times of the total amount of the aforesaid all other components. For example, in Example E1, R*150% represents that the amount of solvent is 187.5 parts by weight (the total amount of all other components excluding inorganic filler, curing accelerator and solvent in Example E1 is 125 parts by weight, so the amount of solvent is 125 parts by weight times 150%, which is 187.5 parts by weight).
SC2050 SMJ: silica, available from Admatechs.
HS-200: silica, available from AGC Corporation.
BN: boron nitride, available from Tokuyama Corporation.
MgCO₃: magnesium carbonate, available from Union Chemical Ind. Co.

### SYNTHESIS EXAMPLE 1

296 parts by weight of 2-bromoethylbenzene (manufactured by Tokyo Chemical Industry Co., Ltd.), 70 parts by weight of α,α′-dichloro-p-xylene (manufactured by Tokyo Chemical Industry Co., Ltd.) and 18.4 parts by weight of methanesulfonic acid (manufactured by Tokyo Chemical Industry Co., Ltd.) were reacted at 130° C. for 8 hours, followed by being cooled to room temperature, neutralized with aqueous sodium hydroxide solution, and extracted with 1200 parts by weight of toluene. The organic layer was washed with water. The solvent and excess 2-bromoethylbenzene were removed by distillation under heating and reduced pressure to obtain the intermediate. The molar ratio of 2-bromoethylbenzene to α,α′-dichloro-p-xylene may be 4:1; methanesulfonic acid was used as an acidic catalyst and may be replaced by other acidic catalysts such as hydrochloric acid and phosphoric acid; and the reaction conditions may be 40 to 180° C. for 0.5 to 20 hours.

22 parts by weight of the aforesaid intermediate, 50 parts by weight of toluene (other aromatic solvents may also be used, such as xylene), 150 parts by weight of dimethyl sulfoxide (other aprotic polar solvents may also be used, such as dimethyl sulfone), 15 parts by weight of water and 5.4 parts by weight of sodium hydroxide (other alkaline catalysts may also be used, such as potassium hydroxide and potassium carbonate) were reacted at 40° C. for 5 hours, followed by being cooled to room temperature, and then added with 100 parts by weight of toluene. The organic layer was washed with water, and the solvent was removed by distillation under heating and reduced pressure to obtain the styrene-based compound of Formula (2).

Compositions and test results of resin compositions of Examples and Comparative Examples are listed below (in part by weight).

TABLE 1
Resin compositions of Examples (in part by weight) and test results

| Component | Name | E1 | E2 | E3 | E4 | E5 |
|---|---|---|---|---|---|---|
| thermosetting resin | SA9000 | 100 | 100 | 100 | | 60 |
| | OPE-2St 2200 | | | | | |
| | Formula (2) | | | | | 40 |
| | BMI-3000 | | | | 50 | |
| | MIR-5000 | | | | 50 | |
| fluorene-containing | Formula (1), n = 0 | 25 | 10 | 40 | 25 | 25 |
| compound | Formula (1), n = 1 to 2 | | | | | |
| | Formula (4), n = 0 | | | | | |
| | Formula (4), n = 10 | | | | | |
| | Formula (5) | | | | | |
| additive | Ricon 100 | | | | | |
| | PCX02 | | | | | |
| | H1052 | | | | | |
| | B-1000 | | | | | |
| | Ricon 184MA6 | | | | | |
| | V-BCB | | | | | |
| | V-NB | | | | | |
| curing accelerator | 25B | 0.15 | 0.15 | 0.15 | 0.15 | 0.15 |
| solvent | MEK | R*150% | R*150% | R*150% | R*150% | R*150% |
| inorganic filler | SC2050 SMJ | 210 | 210 | 210 | 210 | 210 |
| | HS-200 | | | | | |
| | BN | | | | | |
| | MgCO₃ | | | | | |
| Property | Unit | E1 | E2 | E3 | E4 | E5 |
| PCT water absorption ratio | % | 0.27 | 0.22 | 0.33 | 0.27 | 0.23 |
| dielectric constant | none | 2.94 | 2.97 | 2.92 | 3.10 | 3.02 |
| dissipation factor | none | 0.0026 | 0.0029 | 0.0024 | 0.0028 | 0.0027 |
| copper foil peeling strength | lb/in | 3.21 | 3.21 | 3.21 | 3.35 | 3.19 |
| thermal conductivity | W/(m · K) | 0.22 | 0.21 | 0.23 | 0.28 | 0.31 |
| glass transition temperature | ° C. | 210 | 202 | 225 | 231 | 223 |

TABLE 2
Resin compositions of Examples (in part by weight) and test results

| Component | Name | E6 | E7 | E8 | E9 | E10 |
|---|---|---|---|---|---|---|
| thermosetting resin | SA9000 | | | | 100 | |
| | OPE-2St 2200 | 100 | 100 | 100 | | |
| | Formula (2) | | | | | |
| | BMI-3000 | | | | | 50 |
| | MIR-5000 | | | | | 50 |
| fluorene-containing | Formula (1), n = 0 | | | | | |
| compound | Formula (1), n = 1 to 2 | 25 | 10 | 40 | 25 | 25 |
| | Formula (4), n = 0 | | | | | |
| | Formula (4), n = 10 | | | | | |
| | Formula (5) | | | | | |
| additive | Ricon 100 | | | | | |
| | PCX02 | | | | | |
| | H1052 | | | | | |
| | B-1000 | | | | | |
| | Ricon 184MA6 | | | | | |
| | V-BCB | | | | | |
| | V-NB | | | | | |
| curing accelerator | 25B | 0.15 | 0.15 | 0.15 | 0.15 | 0.15 |
| solvent | MEK | R*150% | R*150% | R*150% | R*150% | R*150% |
| inorganic filler | SC2050 SMJ | 210 | 210 | 210 | 210 | 210 |
| | HS-200 | | | | | |
| | BN | | | | | |
| | MgCO₃ | | | | | |
| Property | Unit | E6 | E7 | E8 | E9 | E10 |
| PCT water absorption ratio | % | 0.22 | 0.23 | 0.21 | 0.25 | 0.25 |
| dielectric constant | none | 3.05 | 3.08 | 3.02 | 3.12 | 2.98 |
| dissipation factor | none | 0.0023 | 0.0025 | 0.0022 | 0.0024 | 0.0025 |
| copper foil peeling strength | lb/in | 3.18 | 3.15 | 3.13 | 3.21 | 3.26 |
| thermal conductivity | W/(m · K) | 0.32 | 0.31 | 0.33 | 0.31 | 0.32 |
| glass transition temperature | ° C. | 215 | 205 | 227 | 213 | 245 |

TABLE 3
Resin compositions of Examples (in part by weight) and test results

| Component | Name | E11 | E12 | E13 | E14 | E15 |
|---|---|---|---|---|---|---|
| thermosetting resin | SA9000 | 60 | | | 25 | 10 |
| | OPE-2St 2200 | | | 100 | 10 | 10 |
| | Formula (2) | 40 | 100 | | 10 | 5 |
| | BMI-3000 | | | | 15 | 30 |
| | MIR-5000 | | | | 40 | 45 |
| fluorene-containing | Formula (1), n = 0 | | | 5 | 5 | 10 |
| compound | Formula (1), n = 1 to 2 | 25 | 25 | 20 | 20 | 30 |
| | Formula (4), n = 0 | | | | | |
| | Formula (4), n = 10 | | | | | |
| | Formula (5) | | | | | |
| additive | Ricon 100 | | | | 8 | 5 |
| | PCX02 | | | | 5 | 1 |
| | H1052 | | | 5 | 9 | 10 |
| | B-1000 | | | 10 | 5 | 10 |
| | Ricon 184MA6 | | | 5 | 1 | 1 |
| | V-BCB | | | | 5 | 7 |
| | V-NB | | | | 10 | 9 |
| curing accelerator | 25B | 0.15 | 0.15 | 0.15 | 0.20 | 0.30 |
| solvent | MEK | R*150% | R*150% | R*150% | R*100% | R*200% |
| inorganic filler | SC2050 SMJ | 210 | 210 | 210 | 250 | 360 |
| | HS-200 | | | | 15 | 40 |
| | BN | | | | 25 | 55 |
| | MgCO₃ | | | | 40 | 55 |
| Property | Unit | E11 | E12 | E13 | E14 | E15 |
| PCT water absorption ratio | % | 0.28 | 0.24 | 0.25 | 0.22 | 0.19 |
| dielectric constant | none | 3.08 | 3.05 | 2.78 | 2.77 | 2.81 |
| dissipation factor | none | 0.0024 | 0.0021 | 0.0022 | 0.0016 | 0.0020 |
| copper foil peeling strength | lb/in | 3.20 | 3.13 | 3.24 | 3.27 | 3.20 |
| thermal conductivity | W/(m · K) | 0.32 | 0.34 | 0.40 | 0.45 | 0.51 |
| glass transition temperature | ° C. | 234 | 240 | 215 | 213 | 217 |

TABLE 4
Resin compositions of Comparative Examples (in part by weight) and test results

| Component | Name | C1 | C2 | C3 | C4 | C5 | C6 |
|---|---|---|---|---|---|---|---|
| thermosetting resin | SA9000 | 60 | 100 | 100 | 100 | | |
| | OPE-2St 2200 | | | | | | |
| | Formula (2) | 40 | | | | | |
| | BMI-3000 | | | | | 50 | 50 |
| | MIR-5000 | | | | | 50 | 50 |
| fluorene-containing | Formula (1), n = 0 | | | | | 60 | |
| compound | Formula (1), n = 1 to 2 | | | | | | 60 |
| | Formula (4), n = 0 | | 25 | | | | |
| | Formula (4), n = 10 | | | 25 | | | |
| | Formula (5) | | | | 25 | | |
| additive | Ricon 100 | | | | | | |
| | PCX02 | | | | | | |
| | H1052 | | | | | | |
| | B-1000 | | | | | | |
| | Ricon 184MA6 | | | | | | |
| | V-BCB | | | | | | |
| | V-NB | | | | | | |
| curing accelerator | 25B | 0.15 | 0.15 | 0.15 | 0.15 | 0.15 | 0.15 |
| solvent | MEK | R*150% | R*150% | R*150% | R*150% | R*150% | R*150% |
| inorganic filler | SC2050 SMJ | 210 | 210 | 210 | 210 | 210 | 210 |
| | HS-200 | | | | | | |
| | BN | | | | | | |
| | MgCO₃ | | | | | | |
| Property | Unit | C1 | C2 | C3 | C4 | C5 | C6 |
| PCT water absorption | % | 0.41 | 0.38 | 0.39 | 0.42 | 0.43 | 0.45 |
| ratio | | | | | | | |
| dielectric constant | none | 3.15 | 3.14 | 3.16 | 3.18 | 3.04 | 3.31 |
| dissipation factor | none | 0.0033 | 0.0031 | 0.0033 | 0.0035 | 0.0023 | 0.0025 |
| copper foil peeling | lb/in | 2.89 | 2.93 | 3.01 | 3.05 | 2.81 | 2.75 |
| strength | | | | | | | |
| thermal conductivity | W/(m · K) | 0.23 | 0.22 | 0.25 | 0.22 | 0.23 | 0.28 |
| glass transition | ° C. | 220 | 197 | 198 | 194 | 243 | 252 |
| temperature | | | | | | | |

Samples (specimens) for the properties measured above were prepared as described below and tested and analyzed under specified conditions below.

### 1. Prepreg 1 (PP 1)

Resin composition (all in part by weight) from each Example or each Comparative Example was separately added to a stirred tank and well-mixed to form a varnish.
Then the varnish was loaded to an impregnation tank, and a fiberglass fabric (e.g., 1078 L-glass fiber fabric, available from Asahi) was impregnated into the impregnation tank to adhere the resin composition onto the fiberglass fabric, followed by heating at 100° C. to 140° C. to the semi-cured state (B-stage) to obtain a prepreg 1, having a resin content of about 70%.

### 2. Prepreg 2 (PP 2)

Resin composition (all in part by weight) from each Example or each Comparative Example was separately added to a stirred tank and well-mixed to form a varnish. Then the varnish was loaded to an impregnation tank, and a fiberglass fabric (e.g., 2116 L-glass fiber fabric, available from Asahi) was impregnated into the impregnation tank to adhere the resin composition onto the fiberglass fabric, followed by heating at 100° C. to 140° C. to the semi-cured state (B-stage) to obtain a prepreg 2, having a resin content of about 70%.

### 3. Copper-Containing Laminate 1 (Obtained by Laminating Two Prepregs 1)

Two 0.5 oz hyper very low profile (HVLP) copper foils and two prepregs 1 obtained from 1078 L-glass fiber fabrics impregnated with each Example or Comparative Example were prepared, each prepreg 1 having a resin content of about 70%. A copper foil, two prepregs 1 and a copper foil were superimposed in such order and then subjected to a vacuum condition for lamination at 250 psi to 500 psi and 200° C. to 220° C. for 90 minutes to 120 minutes to form each copper-containing laminate 1. The two prepregs 1 were cured to form an insulation layer between the two copper foils, and the insulation layer has a resin content of about 70%.

### 4. Copper-Containing Laminate 2 (Obtained by Laminating Six Prepregs 1)

The preparation processes were substantially the same as those described in the copper-containing laminate 1, except that the insulation layer was made from six prepregs 1.

### 5. Copper-Containing Laminate 3 (Obtained by Laminating Eight Prepregs 1)

The preparation processes were substantially the same as those described in the copper-containing laminate 1, except that the insulation layer was made from eight prepregs 1.

### 6. Copper-Containing Laminate 4 (Obtained by Laminating Eight Prepregs 2)

Two 0.5 oz hyper very low profile (HVLP) copper foils and eight prepregs 2 obtained from 2116 L-glass fiber fabrics impregnated with each Example or Comparative Example were prepared, each prepreg 2 having a resin content of about 70%. A copper foil, eight prepregs 2 and a copper foil were superimposed in such order and then subjected to a vacuum condition for lamination at 250 psi to 500 psi and 200° C. to 220° C. for 90 minutes to 120 minutes to form each copper-containing laminate 4. The eight prepregs 2 were cured to form an insulation layer between the two copper foils, and the insulation layer has a resin content of about 70%.

### 7. Copper-Free Laminate 1 (Obtained by Laminating Two Prepregs 1)

Copper-containing laminate 1 was etched to remove the copper foils on both sides so as to obtain the copper-free laminate 1 (obtained by laminating two prepregs 1).

### 8. Copper-Free Laminate 2 (Obtained by Laminating Eight Prepregs 1)

Copper-containing laminate 3 was etched to remove the copper foils on both sides so as to obtain the copper-free laminate 2 (obtained by laminating eight prepregs 1).

### 9. Copper-Free Laminate 3 (Obtained by Laminating Eight Prepregs 2)

Copper-containing laminate 4 was etched to remove the copper foils on both sides so as to obtain the copper-free laminate 3 (obtained by laminating eight prepregs 2).

For each sample, test items and test methods are described below.

Pressure cooking test (PCT) water absorption ratio

In the measurement of PCT water absorption ratio, a 2 inch×2 inch copper-free laminate 3 (obtained by laminating eight prepregs 2) sample was placed in a 105±10° C. oven and baked for 1 hour, then cooled at room temperature of about 25° C. for 10 minutes and weighed to give a weight value W1 representing the weight of the copper-free laminate; then the sample was subjected to a pressure cooking test (PCT) by reference to IPC-TM-650 2.6.16.1 for 5 hours of moisture absorption (test temperature of 121° C. and relative humidity of 100%) and wiped to remove residual water on the surface; the sample was weighed again to give a weight value W2 representing the weight of the copper-free laminate after water absorption. The PCT water absorption ratio (%) was calculated as follows: water absorption ratio (%)=[(W2−W1)/W1]×100%.

In the present technical field to which the present disclosure pertains, lower PCT water absorption ratio represents a better property of the sample. A difference in PCT water absorption ratio of greater than or equal to 0.03% represents a substantial difference (i.e., significant technical difficulty) in PCT water absorption ratio of different laminates. For example, articles made from the resin composition disclosed herein have a water absorption ratio in a pressure cooking test as measured by reference to IPC-TM-650 2.6.16.1 of less than or equal to 0.33%, such as between 0.19% and 0.33%.

### Dielectric Constant (Dk)

The aforesaid copper-free laminate 1 (obtained by laminating two prepregs 1) sample was subjected to dielectric constant measurement. Each sample was tested by using a microwave dielectrometer (available from AET Corp.) by reference to JIS C2565 at room temperature (about 25° C.) and under a 10 GHz frequency to obtain the dielectric constant.

In the present technical field to which the present disclosure pertains, lower dielectric constant represents better dielectric properties of the sample, and a difference in dielectric constant of greater than or equal to 0.05 represents a substantial difference (i.e., significant technical difficulty) in dielectric constant of different laminates. For example, articles made from the resin composition disclosed herein have a dielectric constant as measured by reference to JIS C2565 at 10 GHz of less than or equal to 3.12, such as between 2.77 and 3.12.

### Dissipation Factor (Df)

The aforesaid copper-free laminate 1 (obtained by laminating two prepregs 1) was subjected to dissipation factor measurement. Each sample was tested by using a microwave dielectrometer (available from AET Corp.) by reference to JIS C2565 at room temperature (about 25° C.) and under a 10 GHz frequency to obtain the dissipation factor.

In the present technical field to which the present disclosure pertains, lower dissipation factor represents better dielectric properties of the sample, and a difference in dissipation factor of greater than or equal to 0.0003 represents a substantial difference (i.e., significant technical difficulty) in dissipation factor of different laminates. For example, articles made from the resin composition disclosed herein have a dissipation factor as measured by reference to JIS C2565 at 10 GHz of less than or equal to 0.0029, such as between 0.0016 and 0.0029.

### Copper Foil Peeling Strength (Hoz Peeling Strength, Hoz P/S)

In the measurement of copper foil peeling strength, the aforesaid copper-containing laminate 2 (obtained by laminating six prepregs 1) was cut into a rectangular sample with a width of 24 mm and a length of greater than 60 mm, which was etched to remove surface copper foil to leave a rectangular copper foil with a width of 3.18 mm and a length of greater than 60 mm, and tested by using a tensile strength tester by reference to IPC-TM-650 2.4.8 at room temperature (about 25° C.) to measure the force (lb/in) required to separate the copper foil from the insulation layer of the laminate.

In the present technical field to which the present disclosure pertains, higher copper foil peeling strength is better. A difference in copper foil peeling strength of greater than or equal to 0.1 lb/in represents a substantial difference (i.e., significant technical difficulty) in copper foil peeling strength in different laminates. For example, articles made from the resin composition disclosed herein have a copper foil peeling strength as measured by reference to IPC-TM-650 2.4.8 of greater than or equal to 3.13 lb/in, such as between 3.13 lb/in and 3.35 lb/in.

### Thermal Conductivity (Tk)

In the measurement of thermal conductivity, the aforesaid copper-free laminate 2 sample (obtained by laminating eight prepregs 1) with a size of 31 mm*31 mm*0.85 mm was tested by reference to the processes described in ASTM-D5470. The sample was heated by a test apparatus from room temperature (about 25° C.), and after 30 minutes of heating when the temperature was 80° C., a thermal conductivity measurement instrument (model No. LW-9091 ir, available from Long Win Science and Technology Corporation) was used to calculate and analyze to obtain the thermal conductivity (in W/(m·K).

In the present technical field to which the present disclosure pertains, higher thermal conductivity is better, representing that the material is more thermally conductive, and a difference in thermal conductivity of greater than or equal to 0.03 W/(m·K) represents a significant difference (i.e., significant technical difficulty) in thermal conductivity of different laminates. For example, articles made from the resin composition disclosed herein have a thermal conductivity as measured by reference to ASTM-D5470 of greater than or equal to 0.21 W/(m·K), such as between 0.21 W/(m·K) and 0.51 W/(m·K).

### Glass Transition Temperature (Tg)

The copper-free laminate 2 sample (obtained by laminating eight prepregs 1) was subjected to the glass transition temperature measurement. A thermal mechanical analyzer (TMA) was used by reference to the method described in IPC-TM-650 2.4.24.5, during which each sample was heated from 35° C. to 350° C. at a heating rate of 10° C./minute and then subjected to the measurement of glass transition temperature (in° C.).

In the technical field to which the present disclosure pertains, higher glass transition temperature is better. A difference in glass transition temperature of greater than or equal to 3° C. represents a substantial difference (i.e., significant technical difficulty) in glass transition temperature of different laminates. For example, articles made from the resin composition disclosed herein have a glass transition temperature of greater than or equal to 202° C. as measured by reference to IPC-TM-650 2.4.24.5, such as between 202° C. and 245° C.

The following observations can be made from Table 1 to Table 4.

The resin composition containing 100 parts by weight of a thermosetting resin, 10 parts by weight to 40 parts by weight of a fluorene-containing compound of Formula (1) and 210 parts by weight to 400 parts by weight of silica, such as Examples E1 to E15, can all achieve desirable properties including a pressure cooking test (PCT) water absorption ratio of less than or equal to 0.33%, a dielectric constant of less than or equal to 3.12, a dissipation factor of less than or equal to 0.0029, a copper foil peeling strength of greater than or equal to 3.13 lb/in, a thermal conductivity of greater than or equal to 0.21 W/(m·K) and a glass transition temperature of greater than or equal to 202° C. In contrast, Comparative Examples C1 to C6 fail to achieve desirable results in at least one of the aforesaid properties.

In contrast to Examples E5 and E11, Comparative Example C1 not containing the fluorene-containing compound of Formula (1) disclosed herein fails to achieve desirable results in PCT water absorption ratio, dissipation factor and copper foil peeling strength.

In contrast to Examples E1 and E9, Comparative Example C2 not containing the fluorene-containing compound of Formula (1) disclosed herein, but containing a fluorene-containing compound (n=0) of Formula (4), fails to achieve desirable results in PCT water absorption ratio, copper foil peeling strength and glass transition temperature.

In contrast to Examples E1 and E9, Comparative Example C3 not containing the fluorene-containing compound of Formula (1) disclosed herein, but containing a fluorene-containing compound (n=10) of Formula (4), fails to achieve desirable results in PCT water absorption ratio, dissipation factor, copper foil peeling strength and glass transition temperature.

In contrast to Examples E1 and E9, Comparative Example C4 not containing the fluorene-containing compound of Formula (1) disclosed herein, but containing 9,9-bis(4-(2-acryloyloxyethoxy)phenyl)fluorene of Formula (5), fails to achieve desirable results in PCT water absorption ratio, dielectric constant, dissipation factor, copper foil peeling strength and glass transition temperature.

In contrast to Examples E4 and E10, if the amount of the fluorene-containing compound of Formula (1) in the resin composition is not within the range of 10 parts by weight to 40 parts by weight, such as Comparative Example C5 which contains 60 parts by weight of the fluorene-containing compound (n=0) of Formula (1), it will fail to achieve desirable results in PCT water absorption ratio and copper foil peeling strength.

In contrast to Examples E4 and E10, if the amount of the fluorene-containing compound of Formula (1) in the resin composition is not within the range of 10 parts by weight to 40 parts by weight, such as Comparative Example C6 which contains 60 parts by weight of the fluorene-containing compound (n=1 to 2) of Formula (1), it will fail to achieve desirable results in PCT water absorption ratio, dielectric constant and copper foil peeling strength.

In contrast to the resin composition of Examples E1 to E12, the article made therefrom has a thermal conductivity of between 0.21 W/(m·K) and 0.34 W/(m·K). The resin composition of Examples E13 to E15, additionally added with an additive, can significantly increase the thermal conductivity of the article, such as the thermal conductivity of the article being between 0.40 W/(m·K) and 0.51 W/(m·K).

Overall, the resin composition of the present disclosure and an article made therefrom, such as Examples E1 to E15, can all achieve desirable results at the same time including a pressure cooking test (PCT) water absorption ratio of less than or equal to 0.33%, a dielectric constant of less than or equal to 3.12, a dissipation factor of less than or equal to 0.0029, a copper foil peeling strength of greater than or equal to 3.13 lb/in, a thermal conductivity of greater than or equal to 0.21 W/(m·K) and a glass transition temperature of greater than or equal to 202° C.

The above detailed description and examples are merely illustrative in nature and are not intended to limit the embodiments of the subject matter or the applications and uses of such embodiments. As used herein, the term “exemplary” or similar expression means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description can provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A resin composition, comprising:
100 parts by weight of a thermosetting resin;
10 parts by weight to 40 parts by weight of a fluorene-containing compound; and
210 parts by weight to 400 parts by weight of silica;
wherein the fluorene-containing compound has a structure of Formula (1), and n is between 0 and 2: 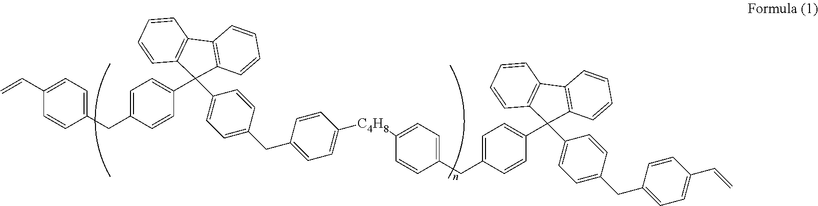
the thermosetting resin comprises a vinyl group-containing polyphenylene ether resin, a maleimide resin, a styrene-based compound or a combination thereof, wherein the styrene-based compound has a structure of Formula (2), and w is between 1 and 20:

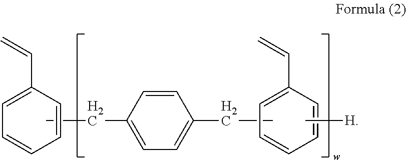

2. The resin composition of claim 1, wherein the vinyl group-containing polyphenylene ether resin comprises a vinylbenzyl group-containing biphenyl polyphenylene ether resin, a methacrylate group-containing polyphenylene ether resin or a combination thereof.

3. The resin composition of claim 1, wherein the maleimide resin comprises 4,4′-diphenylmethane bismaleimide, polyphenylmethane maleimide, bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-dimethylphenyl maleimide, N-2,6-dimethylphenyl maleimide, N-phenylmaleimide, vinyl benzyl maleimide, maleimide containing biphenyl structure, maleimide containing indane structure, maleimide resin containing C₁₀ to C₅₀ aliphatic long chain structure or a combination thereof.

4. The resin composition of claim 1, further comprising an additive which comprises polyolefin, vinylbenzocyclobutene, vinylnorbornene or a combination thereof.

5. The resin composition of claim 1, further comprising inorganic filler different from silica, flame retardant, curing accelerator, polymerization inhibitor, solvent, silane coupling agent, coloring agent, toughening agent or a combination thereof.

6. An article made from the resin composition of claim 1, which comprises a prepreg, a resin film, a laminate or a printed circuit board.

7. The article of claim 6, having a water absorption ratio in a pressure cooking test as measured by reference to IPC-TM-650 2.6.16.1 of less than or equal to 0.33%.

8. The article of claim 6, having a dielectric constant as measured by reference to JIS C2565 at 10 GHz of less than or equal to 3.12.

9. The article of claim 6, having a dissipation factor as measured by reference to JIS C2565 at 10 GHz of less than or equal to 0.0029.

10. The article of claim 6, having a copper foil peeling strength as measured by reference to IPC-TM-650 2.4.8 of greater than or equal to 3.13 lb/in.

11. The article of claim 6. having a glass transition temperature as measured by reference to IPC-TM-650 2.4.24.5 of greater than or equal to 202° C.
